(19) United States
(12) Patent Application Publication
(10) Pub. No.: US 2022/0397071 A1
(43) Pub. Date: Dec. 15, 2022

(54) SKIP-FIRE ENGINE SYSTEM FEATURING DIFFERENT TYPES OF OIL CONTROL SOLENOIDS

(71) Applicant: CUMMINS INC., Columbus, IN (US)

(72) Inventors: J. Steven Kolhouse, Columbus, IN (US); Steven John Small, Columbus, IN (US)

(73) Assignee: CUMMINS INC., Columbus, IN (US)

(21) Appl. No.: 17/776,015

(22) PCT Filed: Nov. 5, 2020
(86) PCT No.: PCT/US2020/059033

§ 371 Date: May 11, 2022

Related U.S. Application Data
(60) Provisional application No. 62/936,682, filed on Nov. 18, 2019.

(51) Int. Cl. F02D 41/00; F01L 13/00

(52) U.S. Cl. CPC F02D 41/0087; F01L 13/0005; F01L 2013/001; F01L 2013/101; F01L 2800/05; F01L 2800/11

(57) ABSTRACT

A system for selectively activating and deactivating cylinders includes a first cylinder positioned in a cylinder block. A first intake or exhaust valve is coupled to the first cylinder and is actuated by a first coupling mechanism. A first oil control solenoid is coupled to the first coupling mechanism, the first oil control solenoid deactivates the first coupling mechanism to maintain the first intake or exhaust valve in a closed position. A second cylinder is positioned in the cylinder block, and a second intake or exhaust valve is coupled to the second cylinder. The second intake or exhaust valve is actuated by a second coupling mechanism. A second oil control solenoid is coupled to the second coupling mechanism, the second oil control solenoid deactivates the second coupling mechanism to maintain the second intake or exhaust valve in a closed position. The first oil control solenoid and the second oil control solenoid have different operating parameters.

### CROSS-REFERENCE TO RELATED APPLICATIONS

The present application claims priority to U.S. Provisional Application No. 62/936,682, filed Nov. 18, 2019, the entire contents of which are incorporated herein.

### TECHNICAL FIELD

The present invention relates generally to dynamic skip fire engine systems.

### BACKGROUND

During normal operation of an internal combustion engine, a camshaft operates to selectively open and close valves coupled to engine cylinders. Opening and closing the valves allows air to flow in to, and exhaust to flow out of, the cylinders during the various cylinder strokes. As the camshaft rotates, cams coupled to the camshaft contact coupling mechanisms that contact rocker arms coupled to the valves. The rotation of the camshaft causes the cams to selectively actuate the rocker arms, which opens and closes the valves. The coupling mechanisms (e.g., pins, etc.) are releasably attached to the rocker arms, and the coupling mechanisms maintain contact with the rocker arms via oil pressure supplied by oil control solenoids.

Dynamic skip fire (DSF) is a cylinder deactivation technology where the decision to fire or skip a cylinder of a multi-cylinder engine is made immediately prior to each firing opportunity. A DSF-equipped engine features the ability to selectively deactivate cylinders on a cylinder event-by-event basis in order to match the requested torque demand at optimum fuel efficiency while maintaining acceptable noise, vibration and harshness (NVH). DSF can also be used in other instances such as, for example, balancing cylinder usage, managing aftertreatment temperatures, warming up the engine, etc.

When a decision to skip a cylinder is made, the oil control solenoid associated with the cylinder is activated. Activating the oil control solenoid reduces or eliminates oil pressure to the coupling mechanism, and the coupling mechanism is decoupled from a valvetrain component (e.g., a rocker arm, etc.). Accordingly, when the camshaft rotates, the valves associated with the deactivated cylinder are not actuated because the rocker arm is decoupled from coupling mechanism.

When decisions are made to dynamically skip one or more cylinders, some cylinders may be skipped more than others, causing some oil control solenoids to cycle on and off more than other oil control solenoids.

### SUMMARY

In one set of embodiments, a dynamic skip fire engine system includes a first cylinder positioned in the cylinder block. A first valve is coupled to the first cylinder. The first valve actuated by a first coupling mechanism. A first oil control solenoid is coupled to the first coupling mechanism. The first oil control solenoid is configured to deactivate the first coupling mechanism so as to maintain the first valve in a closed position. The first oil control solenoid is operable in accordance with a first value of an operating parameter. A second cylinder is positioned in the cylinder block. A second valve is coupled to the second cylinder. The second valve is actuated by a second coupling mechanism. A second oil control solenoid is coupled to the second coupling mechanism. The second oil control solenoid is configured to deactivate the second coupling mechanism so as to maintain the second valve in a closed position. The second oil control solenoid is operable in accordance with a second value of the operating parameter, the second value being different than the first value.

In another set of embodiments, an engine system includes an engine having a first oil control solenoid in communication with a first cylinder and a second oil control solenoid in communication with a second cylinder. The second oil control solenoid different from the first oil control solenoid in at least one performance characteristic.

In yet another set of embodiments, a dynamic skip fire engine system is provided. A first cylinder is positioned in a cylinder block. A first valve is coupled to the first cylinder. A first oil control solenoid is coupled to the first valve and is configured to maintain the first valve in a closed position in accordance with a first value of an operating parameter. A second cylinder is positioned in the cylinder block. A second valve is coupled to the second cylinder. A second oil control solenoid is coupled to the second valve and is configured to maintain the second valve in a closed position in accordance with a second value of the operating parameter, the second value being different than the first value.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIGS. 1A-B are illustrations of a portion of a DSF system, according to a particular embodiment.

FIGS. 2A-B are illustrations of a portion of another DSF system, according to another embodiment.

FIGS. 3A-B are illustrations of a portion of yet another DSF system, according to still another embodiment.

### DETAILED DESCRIPTION

Following below are more detailed descriptions of various concepts related to, and implementations of, methods, apparatuses, and systems for DSF systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Implementations herein relate to systems for using oil control solenoids in a DSF system. In some embodiments, the valves of cylinders in an engine system are indirectly coupled to oil control solenoids that control the operation of the valves. The oil control solenoids associated with cylinders that are skipped disproportionately to other cylinders may function according to different values of operating parameters or according to different performance characteristics to account for the disproportionate number of times the cylinders are skipped during DSF operation. The operating parameter or performance characteristic of an oil control solenoid may refer, for example, to the working life (e.g., life expectancy) of the respective oil control solenoid (e.g., the number of times an oil control solenoid can by cycled on/off before failing), the failure temperature of the respective oil control solenoid (e.g., the highest temperature at which an oil control solenoid can operate), the operating temperature capability of the respective oil control solenoid (e.g., the temperature at which the respective oil control solenoid is designed to operate), the speed at which the respective oil control solenoid responds to a command from a controller, the maximum oil pressure that can be maintained by the respective oil control solenoid, the materials used to manufacture the respective oil control solenoid (e.g., steel, brass, bronze, chrome plating, etc.), the design parameters used in designing the respective oil control solenoid (e.g., the overall size of the solenoid, the size of components of the solenoid, the overall shape of the solenoid, the shape of components of the solenoid, etc.), or another parameter.

### II. Example Oil Control Solenoid Arrangements

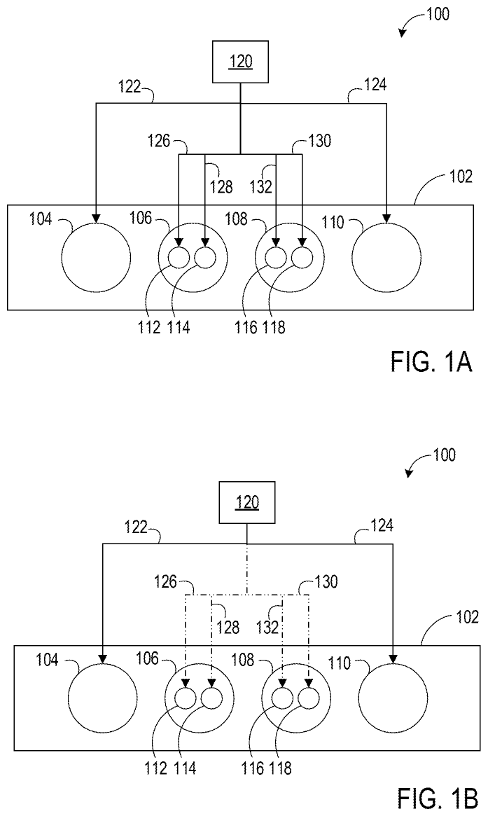

FIGS. 1A-B are illustrations of a portion of a DSF system 100, according to a particular embodiment. The DSF system 100 includes a cylinder block 102, an oil supply 120, and a control module (not shown). The cylinder block 102 includes a first cylinder 104, a second cylinder 106, a third cylinder 108, and a fourth cylinder 110 (collectively referred to herein as “cylinders 104-110”). The cylinders 104-110 are configured to receive pistons that reciprocate within the cylinders 104-110 during operation of an engine. Each of the cylinders 104-110 includes at least one intake valve (not shown) and at least one exhaust valve (not shown). The intake valves are configured to allow air to enter the cylinders in preparation for a combustion event. The exhaust valves are configured to allow exhaust to exit the cylinders after a combustion event has occurred. The intake valves and exhaust valves are controlled by rocker arms that actuate the valves based on rotation of a camshaft. As the camshaft rotates, the cams associated with the camshaft contact a plurality of coupling mechanisms, where each coupling mechanism is releasably coupled to a rocker arm. The coupling mechanisms maintain contact with the rocker arms via oil pressure, and upon removal of oil pressure from the coupling mechanisms, the coupling mechanisms are decoupled from the rocker arms. When the coupling mechanisms are decoupled from the rocker arms, rotation of the camshaft does not actuate the valves (e.g., the valves remain closed when the coupling mechanisms are decoupled from the rocker arms).

The second cylinder 106 includes a first intake oil control solenoid 112 and a first exhaust oil control solenoid 114. The third cylinder 108 includes a second intake oil control solenoid 116 and a second exhaust oil control solenoid 118. The first intake oil control solenoid 112, the first exhaust oil control solenoid 114, the second intake oil control solenoid 116, and the second exhaust oil control solenoid 118 are collectively referred to herein as “oil control solenoids 112-118.” The first intake oil control solenoid 112 and the second intake oil control solenoid 116 control oil flow to the coupling mechanisms associated with the intake valves of the second cylinder 106 and the third cylinder 108, respectively. The first exhaust oil control solenoid 114 and the second exhaust oil control solenoid 118 control oil flow to the coupling mechanisms associated with the exhaust valves of the second cylinder 106 and the third cylinder 108, respectively. The locations of the oil control solenoids 112-118 as shown are approximate and do not indicate precise locations of the oil control solenoids 112-118. In some embodiments, the oil control solenoids 112-118 may be located external to the cylinder block 102. In some embodiments, the oil control solenoids 112-118 may be located on either an intake side of the cylinder block 102 or an exhaust side of the cylinder block 102 (where the intake side of the cylinder block 102 is exposed to lower temperatures than the exhaust side of the cylinder block 102). The oil control solenoids 112-118 may be any type of solenoid configured to start and stop a flow of oil to a coupling mechanism.

The oil supply 120 provides oil to the coupling mechanisms and/or oil control solenoids associated with the cylinders 104-110. A first supply line 122 directs oil from the oil supply 120 to the coupling mechanism associated with the first cylinder 104, and a second supply line 124 directs oil from the oil supply 120 to the coupling mechanism associated with the fourth cylinder 110. A third supply line 126 directs oil from the oil supply 120 to the intake oil control solenoid 112, and a fourth supply line 128 directs oil from the oil supply 120 to the exhaust oil control solenoid 114. A fifth supply line 130 directs oil from the oil supply 120 to the intake oil control solenoid 116, and a sixth supply line 132 directs oil from the oil supply 120 to the exhaust oil control solenoid 118.

The control module is configured to determine whether to initiate a DSF event, whether to terminate a DSF event, and, if a DSF event is initiated, which of the cylinders 104-110 will be skipped during each engine cycle. Accordingly, the control module is in communication with the first intake oil control solenoid 112, the first exhaust oil control solenoid 114, the second intake oil control solenoid 116, and the second exhaust oil control solenoid 118 so as to direct the operation of each oil control solenoid.

As shown, the first cylinder 104 and the fourth cylinder 110 do not include oil control solenoids. In some embodiments, only select cylinders include oil control solenoids. In such embodiments, the determination to provide only select cylinders with oil control solenoids can be based on cost (e.g., it may be less expensive to include fewer oil control solenoids), manufacturing efficiency and simplicity (e.g., it may be more efficient and/or simpler to include fewer oil control solenoids), or prior data (e.g., data may show that only select cylinders are typically skipped during DSF operation, so other cylinders do not need oil control solenoids).

In operation, a vehicle may be operating normally (e.g., in a non-DSF mode) such that oil is directed from the oil supply 120 to the first intake oil control solenoid 112, the first exhaust oil control solenoid 114, the second intake oil control solenoid 116, and the second exhaust oil control solenoid 118 (as indicated by the solid oil path lines in FIG. 1A), thereby allowing each of the cylinders 104-110 to operate normally. The vehicle may then encounter conditions in which DSF operation is more efficient (e.g., the vehicle may be traveling at a substantially constant speed on a highway), and the control module may determine that the second cylinder 106 and the third cylinder 108 should be skipped.

To skip the second cylinder 106 and the third cylinder 108, the control module sends a signal to the oil control solenoids 112-118 to direct the oil control solenoids 112-118 to prevent oil from reaching the coupling mechanisms associated with the intake and exhaust valves of the second cylinder 106 and the third cylinder 108. In response, the oil control solenoids 112-118 prevent oil from reaching the coupling mechanisms (as indicated by the dashed supply lines in FIG. 1B), thereby decoupling the coupling mechanisms from the rocker arms associated with the second cylinder 106 and the third cylinder 108. Accordingly, as the vehicle operates in the DSF mode, the intake and exhaust valves associated with the second cylinder 106 and the third cylinder 108 will not operate, thereby skipping the second cylinder 106 and the third cylinder 108.

In the embodiments described with respect to FIGS. 1A-B, the second cylinder 106 and the third cylinder 108 are shown to include separate oil control solenoids for the intake valves and the exhaust valves. In other embodiments, a single oil control solenoid controls the oil flow to both the intake valve and the exhaust valve for each cylinder. Furthermore, in the embodiments described in FIGS. 1A-B, the cylinder block 102 is shown to include four cylinders; however, in various arrangements the cylinder block 102 can include any number of cylinders (e.g., six cylinders, eight cylinders, twelve cylinders, etc.), and the cylinders can be arranged in any type of configuration (e.g., inline configurations, V configurations, or any other type of cylinder configuration). Additionally, while two cylinders are shown to include oil control solenoids, more or fewer cylinders can include oil control solenoids based on the considerations described.

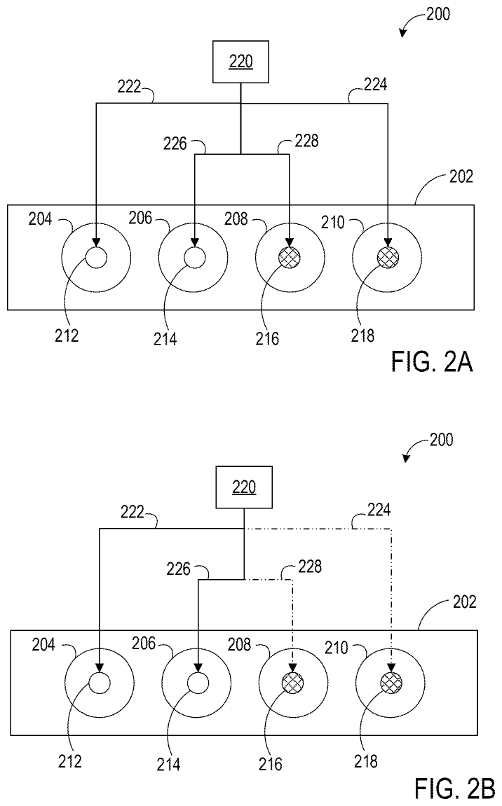

FIGS. 2A-B are illustrations of a portion of another DSF system 200, according to a particular embodiment. The DSF system 200 includes a cylinder block 202, an oil supply 220, and a control module (not shown). The cylinder block 202 includes a first cylinder 204, a second cylinder 206, a third cylinder 208, and a fourth cylinder 210 (collectively referred to herein as “cylinders 204-210”). The cylinders 204-210 are substantially similar in operation to the cylinders 104-110 of FIGS. 1A-B. The first cylinder 204 includes first standard oil control solenoid 212, and the second cylinder 206 includes a second standard oil control solenoid 214. The third cylinder 208 includes a first extended use oil control solenoid 216, and the fourth cylinder 210 includes a second extended use oil control solenoid 218. The first standard oil control solenoid 212 and the second standard oil control solenoid 214 (collectively referred to herein as “standard oil control solenoids 212-214”) can be any type of solenoid typically used to start and stop oil flow to a coupling mechanism. The first extended use oil control solenoid 216 and the second extended use oil control solenoid 218 (collectively referred to herein as “extended use oil control solenoids 216-218”) are configured to have different operating parameters than the standard oil control solenoids 212-214. For example, the extended use oil control solenoids 216-218 have a longer working life (e.g., more on/off cycles before failure) than the standard oil control solenoids 212-214. In some embodiments, the extended use oil control solenoids 216-218 are manufactured with higher quality materials than the standard oil control solenoids 212-214. In some arrangements, the extended use oil control solenoids 216-218 are manufactured with tighter tolerances than the standard oil control solenoids 212-214. In some implementations, the extended use oil control solenoids 216-218 are manufactured to withstand higher temperatures or to have a higher operating temperature capability than the standard oil control solenoids 212-214. The extended use oil control solenoid 216-218 may also be designed with different design parameters than the standard oil control solenoids 212-214. The extended use oil control solenoids 216-218 can also be manufactured in any other way such that the extended use oil control solenoids 216-218 operate for a longer period than the standard oil control solenoids 212-214 (e.g., the extended use oil control solenoids 216-218 can operate for 2-10 times as many cycles as the standard oil control solenoids 212-214). In some embodiments, the standard oil control solenoids 212-214 and the extended use oil control solenoids 216-218 may be located external to the cylinder block 202. The standard oil control solenoids 212-214 and the extended use oil control solenoids 216-218 may be located on either an intake side of the cylinder block 202 or an exhaust side of the cylinder block 202 (where the intake side of the cylinder block 202 is exposed to lower temperatures than the exhaust side of the cylinder block 202). Furthermore, in various configurations the standard oil control solenoids 212-214 and the extended use oil control solenoids 216-218 may be coupled to one or both of an intake valve and an exhaust valve. For example, in an example embodiment the first standard oil control solenoid 212 may be coupled to an intake valve and the first extended use oil control solenoid 216 may be coupled to an exhaust valve.

The oil supply 220 provides oil to the oil control solenoids associated with the cylinders 204-210. A first supply line 222 directs oil from the oil supply 220 to the first standard oil control solenoid 212, and a second supply line 226 directs oil from the oil supply 220 to the second standard oil control solenoid 214. A third supply line 228 directs oil from the oil supply 220 to the first extended use oil control solenoid 216, and a fourth supply line 224 directs oil from the oil supply 220 to the second extended use oil control solenoid 218.

The control module is configured to determine whether to initiate a DSF event, whether to terminate a DSF event, and, if a DSF event is initiated, which of the cylinders 204-210 will be skipped during each engine cycle. Accordingly, the control module is in communication with the standard oil control solenoids 212-214 and the extended use oil control solenoids 216-218 so as to direct the operation of each oil control solenoid.

In some embodiments, data may indicate that the third cylinder 208 and the fourth cylinder 210 are deactivated during a DSF event more often than the first cylinder 204 and the second cylinder 206. To provide for continued operation of the DSF, instead of coupling standard oil control solenoids to the third cylinder 208 and the fourth cylinder 210, the first extended use oil control solenoid 216 and the second extended use oil control solenoid 218 are coupled to the third cylinder 208 and the fourth cylinder 210, respectively.

In operation, a vehicle may be operating normally (e.g., in a non-DSF mode) such that oil is directed from the oil supply 220 to the standard oil control solenoids 212-214 and the extended use oil control solenoids 216-218 (as indicated by the solid oil path lines in FIG. 2A), thereby allowing each of the cylinders 204-210 to operate normally. The vehicle may then encounter conditions in which DSF operation is more efficient (e.g., the vehicle may be traveling at a substantially constant speed on a highway), and the control module may determine that the third cylinder 208 and the fourth cylinder 210 should be skipped.

To skip the third cylinder 208 and the fourth cylinder 210, the control module sends a signal to the extended use oil control solenoids 216-218 to direct the extended use oil control solenoids 216-218 to prevent oil from reaching the coupling mechanisms associated with the intake and exhaust valves of the third cylinder 208 and the fourth cylinder 210. In response, the extended use oil control solenoids 216-218 prevent oil from reaching the coupling mechanisms (as indicated by the dashed supply lines in FIG. 2B), thereby decoupling the coupling mechanisms from the rocker arms associated with the third cylinder 208 and the fourth cylinder 210. Accordingly, as the vehicle operates in the DSF mode, the intake and exhaust valves associated with the third cylinder 208 and the fourth cylinder 210 will not operate, thereby skipping the third cylinder 208 and the fourth cylinder 210.

In the embodiments described in FIGS. 2A-B, the cylinder block 202 is shown to include four cylinders; however, in various arrangements the cylinder block 202 can include any number of cylinders (e.g., six cylinders, eight cylinders, twelve cylinders, etc.). Additionally, while two cylinders are shown to include extended use oil control solenoids and two cylinders are shown to include standard oil control solenoids, more or fewer cylinders can include extended use oil control solenoids or standard oil control solenoids based on the considerations described. The location of the extended use oil control solenoids and the standard oil control solenoids can also be different than as described with respect to FIGS. 2A-B.

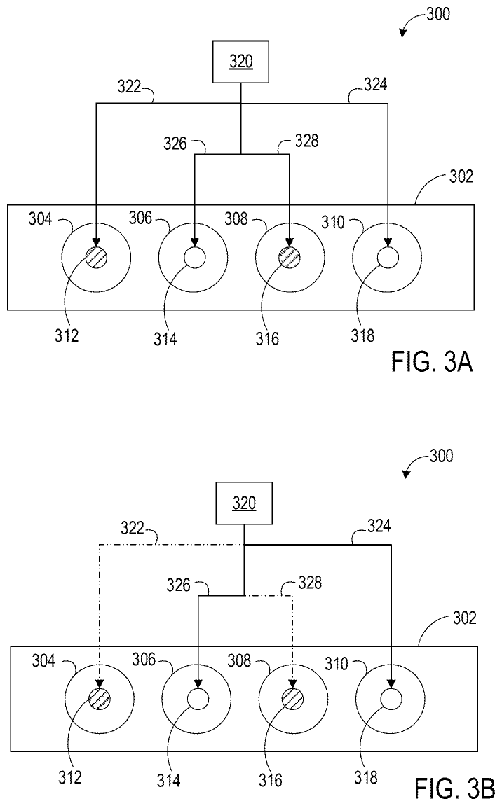

FIGS. 3A-B are illustrations of a portion of yet another DSF system 300, according to a particular embodiment. The DSF system 300 includes a cylinder block 302, an oil supply 320, and a control module (not shown). The cylinder block 302 includes a first cylinder 304, a second cylinder 306, a third cylinder 308, and a fourth cylinder 310 (collectively referred to herein as “cylinders 304-310”). The cylinders 304-310 are substantially similar in operation to the cylinders 104-110 of FIGS. 1A-B. The first cylinder 304 includes a first fast response oil control solenoid 312 and the third cylinder 308 includes a second fast response oil control solenoid 316. The second cylinder 306 includes a first standard response oil control solenoid 314, and the fourth cylinder 310 includes a second standard response oil control solenoid 318. The first standard response oil control solenoid 314 and the second standard response oil control solenoid 318 can be any type of solenoid typically used to start and stop oil flow to a coupling mechanism within a standard response time (e.g., approximately thirty milliseconds). The first fast response oil control solenoid 312 and the second fast response oil control solenoid 316 are configured to have different operating parameters than the first standard response oil control solenoid 314 and the second standard response oil control solenoid 318. For example, the first fast response oil control solenoid 312 and the second fast response oil control solenoid 316 can respond to instructions from the control module faster than the first standard response oil control solenoid 314 and the second standard response oil control solenoid 318 (e.g., within approximately ten milliseconds). In some embodiments, the first fast response oil control solenoid 312 and the second fast response oil control solenoid 316 are manufactured with faster electrical connections than the first standard response oil control solenoid 314 and the second standard response oil control solenoid 318 to facilitate a faster response to the control module. The first fast response oil control solenoid 312 and the second fast response oil control solenoid 316 can also be manufactured in any other way such that they respond to the control module faster than the first standard response oil control solenoid 314 and the second standard response oil control solenoid 318.

In some embodiments, the first fast response oil control solenoid 312, the first standard response oil control solenoid 314, the second fast response oil control solenoid 316, and the second standard response oil control solenoid 318 may be located external to the cylinder block 202. In some embodiments, the first fast response oil control solenoid 312, the first standard response oil control solenoid 314, the second fast response oil control solenoid 316, and the second standard response oil control solenoid 318 may be located on either an intake side of the cylinder block 302 or an exhaust side of the cylinder block 302 (where the intake side of the cylinder block 302 is exposed to lower temperatures than the exhaust side of the cylinder block 302). Furthermore, in various configurations the first fast response oil control solenoid 312, the first standard response oil control solenoid 314, the second fast response oil control solenoid 316, and the second standard response oil control solenoid 318 may each be used in conjunction with one or both of an intake valve and an exhaust valve. For example, in an example embodiment the first fast response oil control solenoid 312 can be coupled to an exhaust valve, and the first standard response oil control solenoid 314 can be coupled to an intake valve.

The oil supply 320 provides oil to the oil control solenoids associated with the cylinders 304-310. A first supply line 322 directs oil from the oil supply 320 to the first fast response oil control solenoid 312, and a second supply line 324 directs oil from the oil supply 320 to the second standard response oil control solenoid 318. A third supply line 326 directs oil from the oil supply 320 to the first standard response oil control solenoid 314, and a fourth supply line 328 directs oil from the oil supply 320 to the second fast response oil control solenoid 316.

The control module is configured to determine whether to initiate a DSF event, whether to terminate a DSF event, and, if a DSF event is initiated, which of the cylinders 304-310 will be skipped during each engine cycle. Accordingly, the control module is in communication with the first fast response oil control solenoid 312, the first standard response oil control solenoid 314, the second fast response oil control solenoid 316, and the second standard response oil control solenoid 318 so as to direct the operation of each oil control solenoid.

In some embodiments, data may indicate that cylinder deactivation must occur very quickly in some instances, and a fast response time (e.g., within ten milliseconds) is required in order to properly execute a DSF cycle in such instances. To provide for operation of a DSF cycle under such conditions, instead of coupling standard response oil control solenoids to the first cylinder 304 and the third cylinder 308, the first fast response oil control solenoid 312 and the second fast response oil control solenoid 316 are coupled to the first cylinder 304 and the third cylinder 308, respectively.

In operation, a vehicle may be operating normally (e.g., in a non-DSF mode) such that oil is directed from the oil supply 320 to the first fast response oil control solenoid 312, the second fast response oil control solenoid 316, the first standard response oil control solenoid 314, and the second standard response oil control solenoid 318, thereby allowing each of the cylinders 304-310 to operate normally. The vehicle may then encounter conditions in which DSF operation is more efficient (e.g., the vehicle may be traveling at a substantially constant speed on a highway), and the control module may determine that the first cylinder 304 and the third cylinder 308 should be skipped because a fast response is needed.

To skip the first cylinder 304 and the third cylinder 308, the control module sends a signal to the first fast response oil control solenoid 312 and the second fast response oil control solenoid 316 to direct them to prevent oil from reaching the coupling mechanisms associated with the intake and exhaust valves of the first cylinder 304 and the third cylinder 308. In response, the first fast response oil control solenoid 312 and the second fast response oil control solenoid 316 prevent oil from reaching the coupling mechanisms (as indicated by the dashed supply lines in FIG. 2B), thereby decoupling the coupling mechanisms from the rocker arms associated with the first cylinder 304 and the third cylinder 308. Accordingly, as the vehicle operates in the DSF mode, the intake and exhaust valves associated with the first cylinder 304 and the third cylinder 308 will not operate, thereby skipping the first cylinder 304 and the third cylinder 308.

In the embodiments described in FIGS. 3A-B, the cylinder block 302 is shown to include four cylinders; however, in various arrangements the cylinder block 302 can include any number of cylinders (e.g., six cylinders, eight cylinders, twelve cylinders, etc.). Additionally, while two cylinders are shown to include fast response oil control solenoids and two cylinders are shown to include standard response oil control solenoids, more or fewer cylinders can include fast response oil control solenoids or standard response oil control solenoids based on the considerations described. The location of the fast response oil control solenoids and the standard response oil control solenoids can also be different than as described with respect to FIGS. 2A-B.

Various arrangements can include any combination of embodiments described herein. For example, in some embodiments a DSF system can include at least one each of a standard oil control solenoid, an extended use oil control solenoid, a standard response oil control solenoid, and a fast response oil control solenoid. In addition, oil control solenoids implemented in various embodiments of DSF systems described herein can be arranged in various combinations and patterns relative to the engine cylinders.

### III. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A dynamic skip fire engine system, comprising:
a first cylinder positioned in a cylinder block;
a first valve coupled to the first cylinder, the first valve actuated by a first coupling mechanism;
a first oil control solenoid coupled to the first coupling mechanism, the first oil control solenoid configured to deactivate the first coupling mechanism so as to maintain the first valve in a closed position, the first oil control solenoid operable in accordance with a first value of an operating parameter;
a second cylinder positioned in the cylinder block;
a second valve coupled to the second cylinder, the second valve actuated by a second coupling mechanism; and
a second oil control solenoid coupled to the second coupling mechanism, the second oil control solenoid configured to deactivate the second coupling mechanism so as to maintain the second valve in a closed position, the second oil control solenoid operable in accordance with a second value of the operating parameter, the second value being different than the first value.

2. The system of claim 1, wherein the operating parameter is a working life of the respective oil control solenoid.

3. The system of claim 1, wherein the operating parameter is a response time of the respective oil control solenoid.

4. The system of claim 1, wherein the operating parameter is a failure temperature of the respective oil control solenoid.

5. The system of claim 4, wherein the failure temperature of the first oil control solenoid is higher than the failure temperature of the second oil control solenoid.

6. The system of claim 5, wherein:
the first oil control solenoid is positioned on an exhaust side of the cylinder block; and
the second oil control solenoid is positioned on an intake side of the cylinder block.

7. An engine system, comprising:
an engine having a first oil control solenoid in communication with a first cylinder and a second oil control solenoid in communication with a second cylinder, the second oil control solenoid different from the first oil control solenoid in at least one performance characteristic.

8. The system of claim 7, wherein the performance characteristic is a response time of the respective oil control solenoid.

9. The system of claim 7, wherein the performance characteristic is a working life of the respective oil control solenoid.

10. The system of claim 7, wherein the performance characteristic is an operating temperature of the respective oil control solenoid.

11. The system of claim 7, wherein the performance characteristic is a material of the respective oil control solenoid.

12. The system of claim 7, wherein the performance characteristic is a design parameter of the respective oil control solenoid.

13. A dynamic skip fire engine system comprising;
a first cylinder positioned in a cylinder block;
a first valve coupled to the first cylinder;
a first oil control solenoid coupled to the first valve and configured to maintain the first valve in a closed position in accordance with a first value of an operating parameter;
a second cylinder positioned in the cylinder block;
a second valve coupled to the second cylinder; and
a second oil control solenoid coupled to the second valve and configured to maintain the second valve in a closed position in accordance with a second value of the operating parameter, the second value being different than the first value.

14. The system of claim 13, wherein the operating parameter is a working life of the respective oil control solenoid.

15. The system of claim 13, wherein the operating parameter is a response time of the respective oil control solenoid.

16. The system of claim 13, wherein the operating parameter is a failure temperature of the respective oil control solenoid.

17. The system of claim 16, wherein the failure temperature of the first oil control solenoid is higher than the failure temperature of the second oil control solenoid.

18. The system of claim 13, wherein the first valve is an intake valve and the second valve is an exhaust valve.

19. The system of claim 13, further comprising a control module communicatively coupled with the first oil control solenoid and the second oil control solenoid, the control module configured to determine whether to maintain the first valve and the second valve in their respective closed positions.

20. The system of claim 19, wherein the determination to maintain the first valve in the closed configuration is based on the first value of the operating parameter and the determination to maintain the second valve in the closed configuration is based on the second value of the operating parameter.
